(19) United States
(12) Patent Application Publication
(10) Pub. No.: US 2004/0007108 A1
(43) Pub. Date: Jan. 15, 2004

(54) Paper cutter with structural safety latch

(76) Inventors: Gerald Paul Fregeolle, Statesville, NC (US); Michael Lee Parrish, Huntersville, NC (US)

Correspondence Address: Gregory S. Bernabeo, Esq., Synnestvedt & Lechner LLP, 2600 Aramark Tower, 1101 Market Street, Philadelphia, PA, 19107-2950, US

(21) Appl. No.: 10/403,247

(22) Filed: Mar. 28, 2003

Related U.S. Application Data
(60) Provisional application No. 60/395,007, filed on Jul. 11, 2002.

(51) Int. Cl. B26D 1/00; B26D 5/08

(52) U.S. Cl. 83/13; 83/607

(57) ABSTRACT

A paper cutter having a structural safety latch includes a sheet-supporting base having a side bearing a cutting edge. A stud is joined to the base (or cutting arm) and extends laterally therefrom transversely to the cutting edge. A blade-supporting cutting arm is pivotally mounted to the base for pivotal motion in a substantially vertical plane to cut sheets overhanging the cutting edge. The cutting arm (or base) defines a recess for receiving the stud. The recess is positioned for alignment with the stud when the cutting arm is in a closed position relative to the base. In this manner, the cutting arm is vertically moveable for cutting sheet material and laterally moveable for engaging and disengaging the recess with the stud to latch and unlatch the cutting arm when in the closed position. A safety latch for a paper cutter and a method of operating such a paper cutter is also provided.

### CROSS-REFERENCE TO RELATED APPLICATION

This application claims the benefit of U.S. Provisional Patent Application No. 60/395,007, filed Jul. 11, 2002, the entire disclosure of which is hereby incorporated herein by reference.

### FIELD OF THE INVENTION

The present invention relates generally to a cutter for sheet material, and particularly to a paper cutter having a structural safety latch.

### DISCUSSION OF RELATED ART

Cutters or trimmers for sheet material, typically referred to as paper cutters, are in widespread use in educational, institutional, commercial, corporate and other environments for cutting paper, cardboard or sheets of other materials. An exemplary paper cutter has a flat cutting board base that has a sharp cutting edge on a side of the base, and a cutting arm pivotally mounted to the base adjacent the sharp cutting edge. The cutting arm supports a sharp blade which cooperates with the cutting edge on the side of the base to cut any sheets therebetween when the cutting arm is pivoted to draw its blade down along the cutting edge.

While these paper cutters are very effective and efficient, they pose a risk of injury to the user while the cutting arm is raised with the sharp blade exposed.

U.S. Pat. No. 5,320,011 to Lee discloses a paper cutter safety latch that is pivotally mounted to the cutting arm to releaseably latch to the base. U.S. Pat. No. 4,957,235 to Beno et al. discloses a slidable lockpin housed in the base that can be extended to lock a cutting arm in a closed position or retracted to render the cutting arm moveable. Another safety latch that is well known involves a hook rotatably mounted on the base, e.g. with a screw and washer, for latching the cutting arm to the base. These arrangements require additional moveable parts, and additional assembly steps to install such parts, and therefore add undesirably to manufacturing costs for the paper cutter.

What is needed is a paper cutter having a safety latch that eliminates or reduces such costly parts and/or related assembly steps and helps prevent unintentional raising of the cutting arm and exposing of the blade.

### SUMMARY OF THE INVENTION

The present invention provides a paper cutter having a structural safety latch that helps prevent unintentional exposing of the blade and resulting injuries. The structural safety latch is integral to the structure of the paper cutter and therefore eliminates or reduces costly parts and/or assembly steps. Such a safety latch is particularly useful when the paper cutter is transported in other than a substantially horizontal orientation.

In one embodiment of the present invention, a safety latch is provided for a paper cutter having a base for supporting sheet material to be cut and a cutting arm pivotally connected to the base for pivotal motion in a substantially vertical plane. The safety latch includes a fixed stud extending laterally of the base and a recess configured for receiving the stud. The recess is positioned for alignment with the stud when the cutting arm is in a closed position adjacent the base. The stud may be positioned on either the base or the cutting arm; the recess is positioned on the other of the base or cutting arm. Preferably the stud and recess are integrally formed with the base and cutting arm, e.g. by injection molding.

In another embodiment of the present invention, a paper cutter having a structural safety latch is provided. The paper cutter includes a base for supporting material to be cut having a side bearing a cutting edge. A stud is joined to the base and extends laterally therefrom transversely to the cutting edge. A cutting arm having a blade is pivotally mounted to the base for pivotal motion in a substantially vertical plane to cut sheet material positioned on the base to overhang the cutting edge. The cutting arm defines a laterally extending recess for laterally receiving the stud. The recess is positioned on the cutting arm for alignment with the stud when the cutting arm is in a closed position. In this manner, the cutting arm is vertically moveable for cutting sheet material and laterally moveable for engaging and disengaging the recess with the stud to latch and unlatch the cutting arm.

A method of using a paper cutter with such a safety latch is also provided.

### DESCRIPTION OF THE DRAWINGS

FIG. 1 is a perspective view of a paper cutter in accordance with an exemplary embodiment of the present invention;

FIG. 2 is a partial perspective view of the paper cutter of FIG. 1;

FIG. 3 is a partial cross-sectional view of the base of the paper cutter of FIG. 1, taken along line 3-3 of FIG. 2, showing the stud projecting from the base and engaging the recess on the cutting arm;

FIG. 3A is a partial cross-sectional view of the base of the paper cutter of FIG. 1, taken along line 3-3 of FIG. 2, showing the stud projecting from the base and the cutting arm in a laterally displaced position;

FIG. 3B is a partial cross-sectional view of the base of the paper cutter of FIG. 1, taken along line 3-3 of FIG. 2, showing the stud projecting from the base and the cutting arm in a laterally displaced position in which the stud and recess may be engaged by lateral displacement of the cutting arm;

FIG. 4 is a partial perspective view of the cutting arm of the paper cutter of FIG. 1, showing the recess for receiving the stud;

FIG. 5 is a partial cut-away view of the base of a paper cutter in accordance with an alternative embodiment of the present invention; and

FIG. 6 is a partial cross-sectional view of the paper cutter of FIG. 5, taken along line 6-6 of FIG. 5.

### DETAILED DESCRIPTION

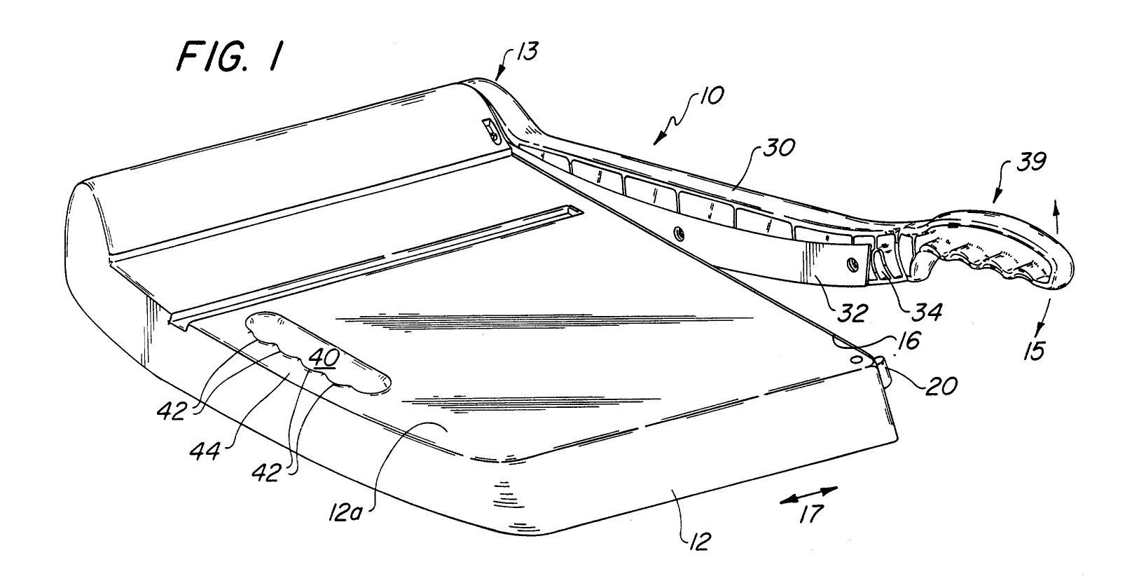

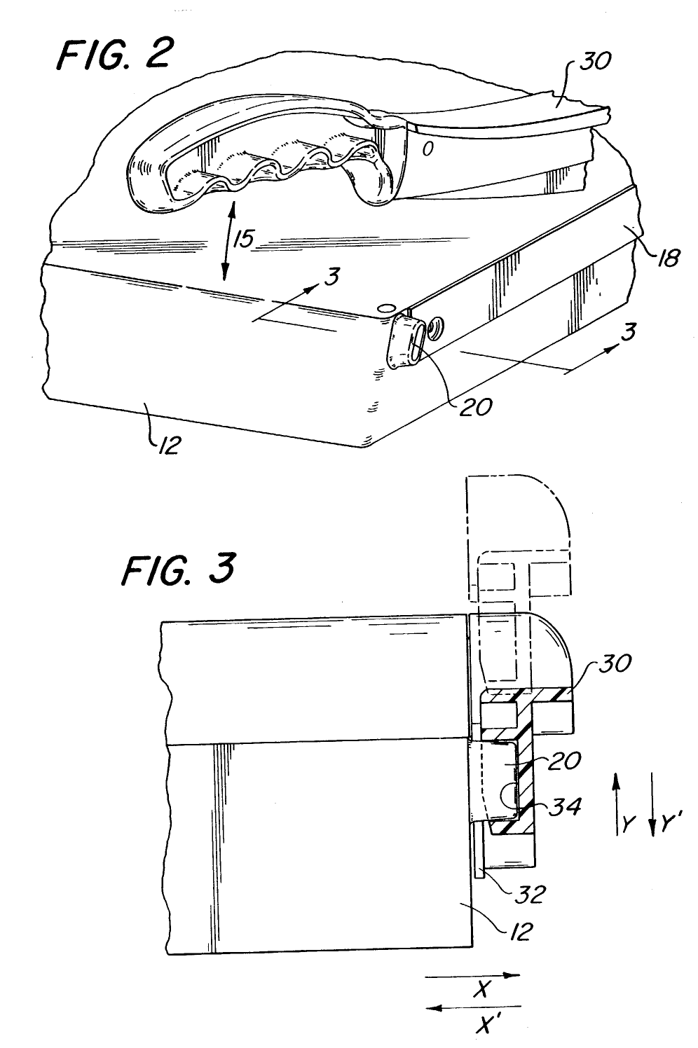

FIGS. 1-4 show a paper cutter 10 in accordance with a first exemplary embodiment of the present invention. As shown in FIGS. 1 and 2, the paper cutter 10 is of a type known in the art in that it includes a base 12 having a surface 12a for supporting sheets to be cut, and a cutting arm 30 pivotally mounted at arm end 13 to the base 12 for pivotal motion 15 in a substantially vertical plane. The base 12 and cutting arm 30 may be formed primarily of a synthetic resin to provide a relatively lightweight and low cost paper cutter. The cutting arm 30 has a blade 32 supported thereon, such as a steel blade, for cutting sheet material. For example, the blade 32 may be fastened to the cutting arm 30 by screws or by injection molding the cutting arm to interlock with the blade 32. The base 12 provides a cutting edge 16 for cooperating with the blade 32 of the cutting arm 30 to cut sheets.

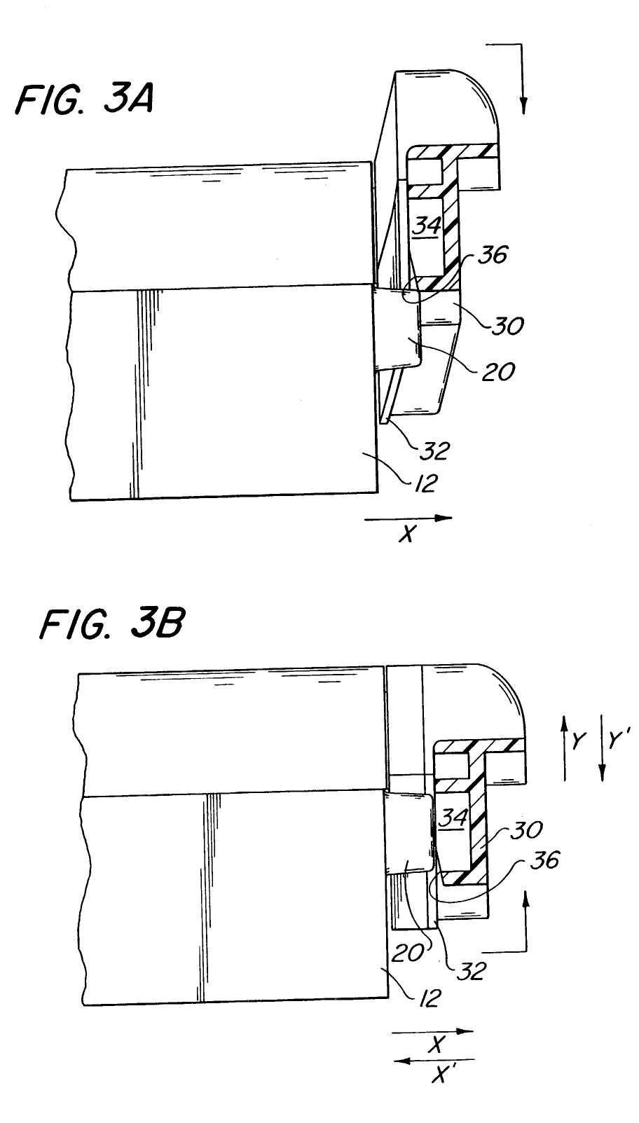

In accordance with the present invention, a safety latch is provided in the form of a stud 20 and a complementary recess 34 configured to receive the stud that are engageable upon lateral movement of the cutting arm. In this manner, the stud and recess are interengageable with one another to latch the cutting arm 30 to the base 12 when in a closed position adjacent the base, as shown in FIG. 3. With reference to FIGS. 1-4, the stud 20 extends in a lateral direction 17 from the base 12 transversely to the cutting edge 16, as shown in FIG. 1. As shown in FIGS. 14, the stud 20 is fixedly joined to the base 12 and extends transversely to the substantially vertical plane in which the cutting arm 22 is pivotable.

Preferably, the stud 20 is integrally formed with the base, e.g. by injection molding the stud 20 and the base 12 as an integral unit. In this manner, additional screws, washers, catches, etc. for a safety latch, and related assembly steps, are reduced or eliminated. The stud 20 is positioned on the base to interfere with the cutting arm 30 when pivoted in the substantially vertical plane to nearly the end of its downward stroke. In this manner, unlatching (and latching) of the cutting arm 30 cannot be achieved by the usual vertical pivoting motion, but rather may be achieved only with a deliberate lateral motion, as discussed further below.

Preferably, the stud 20 is a projection elongated in a direction of pivotal motion 15 of the cutting arm 30, as best shown in FIGS. 1-3B.

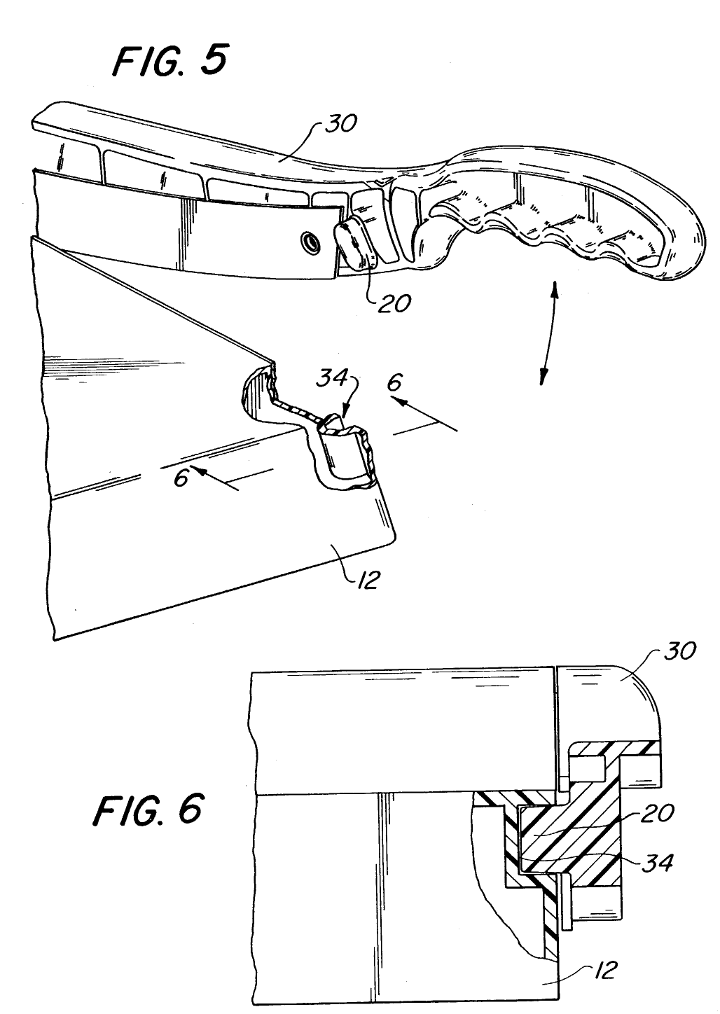

A laterally extending recess 34 is provided for receiving the stud 20. In the embodiment shown in FIGS. 1-4, the recess 34 is positioned on the cutting arm 30 for alignment with the stud 20 when the cutting arm 30 is in a closed position, i.e. in a lowered position in which the blade's edge is not exposed above the base 12 (see FIGS. 3A and 3B). Preferably, the recess 34 is integrally formed with the cutting arm 30, e.g. by injection molding the recess 34 into the cutting arm 30. In this manner, additional parts for a safety latch, and related assembly steps, are reduced or eliminated. An alternative embodiment is discussed below with reference to FIGS. 5 and 6.

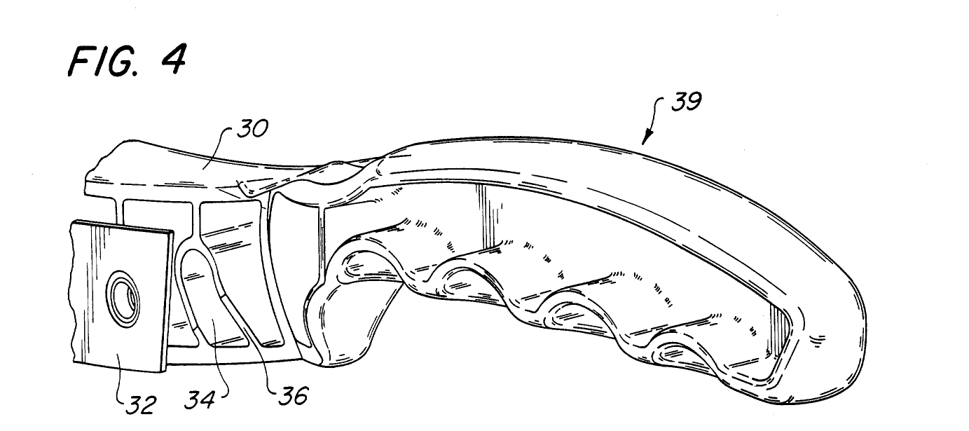

As best shown in FIGS. 3A, 3B and 4, the cutting arm 30 defines a guide surface 36 for urging the cutting arm 30 away from the base 12 as the cutting arm 30 is pivoted downward. In this manner, the cutting arm 30 is urged into a position for laterally receiving the stud 20, as shown in FIG. 3B, as the cutting arm 30 is pivoted downward. This is illustrated in the sequence of FIGS. 3A and 3B. More specifically, the guide surface 36 slopes away from the base 12 moving downwardly, as shown. The guide surface 36 is positioned to cause the cutting arm 30 to ride over the stud 20 as the cutting arm is pivoted downward (see FIGS. 3A and 3B). This causes the cutting arm 30 to deflect outwardly away from the base 12 adjacent the stud 20 so as not to interfere with the stud. The guide surface 36, and stud 20, are preferably positioned on the cutting arm 30 adjacent its distal end 39 to cause minimal deflection thereof. In this manner, the deflection of the cutting arm 30 does not to appreciably interfere with the pivoting joint of the cutting arm 30.

When the cutting arm's distal end 39 is positioned to align the stud 20 with the recess 34, as shown in FIG. 3B, the stud 20 is aligned for lateral mating with the recess 34 to latch the cutting arm 30 to the base 12. The lateral mating may require lateral urging by the user but may be assisted by a rebounding effect of the resiliently deformed synthetic resin material of the cutting arm 30 and/or the pivot pin mounting the cutting arm 30 to the base 12. FIG. 3 shows the stud 20 mated with the recess 34 after lateral force is applied in direction X′ of FIG. 3B.

In operation, the paper cutter 10 is placed on a substantially flat surface and the cutting arm 30 is vertically pivoted to an open (raised) position in which the blade is exposed. Sheet material to be cut is positioned on the base 12 to overhang the cutting edge 16.

If the cutting arm 30 is initially latched to the base 12, i.e. the stud 20 of the base 12 is received in the cutting arm's recess 34, the cutting arm 30 cannot simply be pivoted vertically to the open position as the stud 20 extends into and holds the cutting arm 30 in the closed position. Accordingly, the user must first apply a lateral force to the cutting arm 30 in direction X, as shown in FIG. 3, to resiliently deflect the distal end 39, with the recess 34, to clear the stud 20. The cutting arm 30 may then be pivoted vertically to the open position by providing a vertical lifting force in direction Y, as shown in FIGS. 3 and 3B. The cutting arm 30, which is constructed of a resilient material, will resiliently return toward the base 12 and into a cutting position as it is pivoted vertically and as the lateral force in direction X is removed.

With the cutting arm 30 in an open position, sheet(s) to be cut may be positioned for cutting by causing a portion of the sheet(s) to overhang the cutting edge 16.

The user then applies a downward force, direction Y′ in FIGS. 3 and 3B, to the cutting arm 30 to cause the blade 32 to slidingly contact the cutting edge 16 and cut any sheet(s) therebetween. The cutting arm 30 may be vertically pivoted to a position for completing the cut without any interference between the stud 20 and the cutting arm 30.

As the cutting arm 30 continues to move towards its bottom-most position, the stud 20 of the base 12 will begin to interfere with the structure of the cutting arm 30 and its vertical pivoting. The user must then apply a lateral force (e.g. rightward as indicated as direction X in FIGS. 3 and 3B) to the cutting arm 30 to allow it to clear the stud 20, and a vertical lowering force to align the cutting arm's recess 34 with the stud 20. When the stud 20 and recess 34 are aligned, a reverse lateral force (e.g. leftward as indicated as direction X′ in FIGS. 3 and 3B) is applied to the cutting arm 30 to urge it toward the base 12 and cause the stud 20 to laterally enter the recess 34, as shown in FIG. 3. This latches the cutting arm 30 in a closed position in which the blade is not exposed. The cutting arm can no longer be vertically pivoted to expose the blade because the recess 34 is positively engaged by the stud 20. Rather, the cutting arm 30 may be pivoted only after a deliberate lateral motion of the cutting arm 30 to disengage the base's stud 20 from the cutting arm's recess 34. In this manner, the cutting arm 30 is vertically moveable for cutting sheet material and laterally moveable for engaging and disengaging the recess with the stud to latch and unlatch the cutting arm.

Once the cutting arm 30 is latched to the base, the paper cutter 10 may be carried in any orientation without risk of unintentional movement of the cutting arm and exposure of the blade. For example, the paper cutter 10 may be carried in a substantially vertical position by manually grasping the paper cutter 10 by an integral handle 44, which is formed as an integral part of the base 12. More specifically, the base defines an opening 40 therethrough, internal to a perimeter of the base 12, to allow an individual's fingers to pass therethrough, as shown in FIG. 1. In a preferred embodiment, the base 12 is contoured such that the opening 40 defines a plurality of arcuate finger holds 42 for interfitting with the individual's fingers, as shown in FIG. 1. For example, base 12 may be injection molded to define the opening 40, finger holds 42 and handle 44.

FIGS. 5 and 6 show an alternative embodiment in which the positions of the stud and recess are reversed. In particular, the stud 20 is positioned on the cutting arm 30 and the recess 34 is positioned on the base 12. Optionally, the stud 20 is integrally formed with the cutting arm 30 and the recess 34 is integrally formed into the base 12, e.g. by injection molding. Optionally, the stud 20 defines a guide surface (not shown) for laterally urging the cutting arm 30 away from the base 12 as the cutting arm 30 is pivoted in the substantially vertical plane. In this manner, the cutting arm 30 is urged into position for lateral mating of the stud 20 with the recess 34, as generally discussed above.

In the particular embodiments shown in FIGS. 1-6, the base 12 supports a blade 18 which is fastened, e.g. by screws or by injection molding of the base 12 around the blade 18 (as best shown in FIG. 2), in a substantially vertical position on the side 14 of the base 12 to expose a cutting edge 16 for cooperating with the blade 32 of the cutting arm 30. This vertical blade orientation on the base has been found to be particularly advantageous, as compared to a blade mounted horizontally on the top surface 12a of the base 12 as well known in the art, as disclosed in detail in U.S. patent application Ser. No. ______ (Attorney Docket No. P25,631 USA), filed concurrently herewith, now U.S. Pat. No. ______, the entire disclosure of which is hereby incorporated herein by reference.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A safety latch for a paper cutter having a base for supporting sheet material to be cut and a cutting arm pivotally connected to the base for pivotal motion in a substantially vertical plane, said safety latch comprising:
a stud extending from one of said base or cutting arm toward the other of said base or cutting arm; and
a recess disposed on the other of said one of said base or cutting arm, said recess being configured to receive said stud to latch said cutting arm to said base when said cutting arm is in a closed position adjacent said base;
said cutting arm being laterally moveable for engaging and disengaging said stud with said recess when said cutting arm is in said closed position, said cutting arm being vertically moveable for cutting sheet material when said stud is disengaged from said recess.

2. The safety latch of claim 1, wherein said stud is positioned to interfere with said cutting arm as it is pivoted in said substantially vertical plane.

3. The safety latch of claim 1, wherein said stud is fixedly joined to said base and extends transversely to said substantially vertical plane.

4. The safety latch of claim 3, wherein said stud is integrally formed with said base.

5. The safety latch of claim 3, wherein said cutting arm defines said recess.

6. The safety latch of claim 1, wherein said cutting arm a defines a guide surface for urging said cutting arm laterally away from said base into a position for laterally receiving said stud as said cutting arm is pivoted in said substantially vertical plane.

7. The safety latch of claim 1, wherein said base defines a guide surface for urging said cutting arm laterally away from said base into a position for laterally receiving said stud as said cutting arm is pivoted in said substantially vertical plane.

8. The safety latch of claim 1, wherein said stud is fixedly joined to said cutting arm and extends transversely to said substantially vertical plane.

9. The safety latch of claim 8, wherein said stud is integrally formed with said cutting arm.

10. The safety latch of claim 8, wherein said base defines said recess.

11. The safety latch of claim 1, wherein said stud comprises an elongated projection, said projection being elongated in a direction of pivotal motion of said cutting arm.

12. The paper cutter of claim 1, wherein said base defines an opening internal to a perimeter thereof, said opening extending through said base to allow an individual's fingers to pass therethrough.

13. The paper cutter of claim 12, wherein said opening defines a plurality of arcuate finger holds for interfitting with the individual's fingers.

14. A paper cutter comprising:
a base for supporting material to be cut, said base having a side bearing a cutting edge;
a cutting arm having a blade, said cutting arm being pivotally mounted to said base for pivotal motion in a substantially vertical plane to cut sheet material positioned on said base; and
a safety latch according to claim 1.

15. A paper cutter comprising:
a base for supporting material to be cut, said base having a side bearing a cutting edge;
a stud joined to said base and extending laterally therefrom transversely to said cutting edge; and
a cutting arm having a blade, said cutting arm being pivotally mounted to said base for pivotal motion in a substantially vertical plane to cut sheet material positioned on said base, said cutting arm defining a recess for receiving said stud, said recess being positioned on said cutting arm for alignment with said stud when said cutting arm is in a closed position adjacent said base;
whereby said cutting arm is vertically moveable for cutting sheet material and laterally moveable for engaging and disengaging said stud with said recess to latch and unlatch said cutting arm.

16. The paper cutter of claim 15, wherein said stud is positioned to interfere with said cutting arm as it is pivoted in said substantially vertical plane.

17. The paper cutter of claim 15, wherein said stud is fixedly joined to said base and extends transversely to said substantially vertical plane.

18. The paper cutter of claim 17, wherein said stud is integrally formed with said base.

19. The paper cutter of claim 15, wherein said cutting arm a defines a guide surface for urging said cutting arm laterally away from said base into a position for laterally receiving said stud as said cutting arm is pivoted in said substantially vertical plane.

20. The paper cutter of claim 15, wherein said base defines a guide surface for urging said cutting arm laterally away from said base into a position for laterally receiving said stud as said cutting arm is pivoted in said substantially vertical plane.

21. The paper cutter of claim 15, wherein said base defines an opening internal to a perimeter thereof, said opening extending through said base to allow an individual's fingers to pass therethrough.

22. The paper cutter of claim 23, wherein said opening defines a plurality of arcuate finger holds for interfitting with the individual's fingers.

24. A method for operating a paper cutter having a base for supporting sheet material to be cut and a cutting arm pivotally connected to the base for pivotal motion in a substantially vertical plane, said method comprising:
applying lateral force to the cutting arm to disengage a safety latch of the paper cutter when the cutting arm is in a closed position adjacent said base; and
applying vertical force to the cutting arm to pivot the cutting arm.

25. The method of claim 24, wherein said lateral force is applied to disengage the cutting arm from the base.

26. The method of claim 24, wherein said lateral force is applied to disengage a stud joined to one of said base or said cutting arm from a recess disposed on the other of said one of said base or cutting arm, said recess being configured to receive said stud when said cutting arm is in said closed position.
